(19) United States
(12) Patent Application Publication
(10) Pub. No.: US 2026/0138084 A1
(43) Pub. Date: May 21, 2026

(54) PROTECTIVE SULFUR REMOVAL SYSTEM FOR ENHANCED METHANE SLIP CATALYSTS IN SULFUR-CONTAINING EXHAUST

(71) Applicant: CDTi Advanced Materials, Inc., Oxnard, CA (US)

(72) Inventors: Jason C. Michl, Oxnard, CA (US); Blake Hermann, Oxnard, CA (US); Edward J. Lee, Ventura, CA (US); Campbell McConnell, San Francisco, CA (US); Ru-Fen Liu, Ventura, CA (US)

(21) Appl. No.: 19/394,448

(22) Filed: Nov. 19, 2025

Related U.S. Application Data
(60) Provisional application No. 63/722,338, filed on Nov. 19, 2024.

(51) Int. Cl. B01D 53/50; B01J 20/18; B01J 23/44

(52) U.S. Cl. CPC B01D 53/508; B01J 20/183; B01J 23/44; B01D 2252/10; B01D 2257/302; B01D 2259/40083; B01J 2220/42

(57) ABSTRACT

A sulfur trap system is provided for protecting methane oxidation catalysts (MOC) from sulfur poisoning in sulfur-containing exhaust. The trap is positioned upstream of the MOC and includes a washcoat comprising zeolite, cerium-based oxygen-storage material, and alumina, and an overcoat containing copper, manganese, and cerium oxides. The mixed metal oxide and support formulation delivers high sulfur adsorption at engine exhaust temperatures, reducing sulfur to safe levels and extending the operational life and methane conversion performance of downstream palladium-based MOC systems.

### CROSS-REFERENCE TO RELATED APPLICATIONS

This application claims priority under 35 U.S.C. § 119(e) of the U.S. Provisional Patent Application Ser. No. 63/722,338, filed Nov. 19, 2024 and titled, “METHANE ABATEMENT CATALYTIC SYSTEM FOR SULFUR CONTAINING POST-COMBUSTION NATURAL GAS EXHAUST,” which is hereby incorporated by reference in its entirety for all purposes.

### FIELD OF INVENTION

The present invention relates to catalysts. Specifically, the present invention relates to methane abatement catalyst systems

### BACKGROUND OF THE INVENTION

The combustion process of a dual fuel powered engine involves mixing natural gas and air, then compressing the mixture while injecting a small amount of diesel fuel for ignition. Majority of dual fuel engines inject diesel into the combustion chamber, followed by a second direct injection of natural gas for combustion. After combustion, the unburned methane slips to the exhaust along with other emissions such as CO, NOx and SOx (predominately Sulfur dioxide, e.g., SO₂). Furthermore, although methane contains less carbon compared to other fossil fuels, it is a highly potent greenhouse gas with a global warming potential (GWP) 86 times greater than that of carbon dioxide over a 100-year timeframe.

Consequently, a methane slip catalyst, specifically, a methane oxidation catalyst (MOC), is employed to convert methane into carbon dioxide, which has a lower global warming potential, thereby providing an effective mitigation strategy. Palladium-based catalysts are most effective for removing methane from engine or post-combustion exhaust by oxidizing methane but are easily deactivated by sulfur poisoning.

### SUMMARY OF THE INVENTION

To address this challenge, a sulfur removal system using a monolith contactor can be added before the Pd catalyst to filter SOx and prevent the catalyst from poisoning. This disclosure offers an efficient solution for sustaining catalytic methane oxidation in the presence of SOx.

In an aspect, a sulfur trap is configured to extract sulfur dioxide from exhaust or flue gases, thereby protecting methane slip catalysts or any other downstream aftertreatments and enhancing their operational longevity.

In another aspect, a catalyst aftertreatment system is designed to abate the methane emissions in the exhaust. The system used to remove methane includes a methane oxidation catalyst (MOC). In some embodiments, MOC contains Platinum Group Metal (PGM) catalyst in the system.

In marine shipping industry, 0.05% to 0.5% sulfur-containing diesels are used in dual fuel engines which are run under lean air-fuel ratio for power generation. The methane slip catalyst such as MOC suffers severely by post-combustion sulfur chemically poisoning the active sites. In other industrial process, Methane from pipelines may mix with sulfur-containing hydrocarbons and hydrogen sulfide H₂S; when burned in generators, it produces trace SOx in the exhaust, which can deactivate the aftertreatment such as MOC.

In an example, for a MOC that contains 400 g/ft³ PGM loading at 60K h⁻¹ space velocity, the initial >99% CH₄ conversion quickly degrades below <50% CH₄ conversion after 58 hrs on stream with less than 1 ppm Sulfur in the exhaust. The above-mentioned PGM loading is provided as an example. Any other size and weight range of the PGM is within the scope of the present disclosure. For example, PGM loading between 100 g/ft³ to 400 g/ft³ for ship engines is used in some embodiments.

To maximize the performance of methane abatement MOC system, it is beneficial to address the sulfur and hydrothermal degradation issues. Large industrial need of an MOC system comes from marine space for they contribute 3%-5% global CO₂ emission. A ship can be retrofitted to convert the engine to run on dual fuels. The ship carries liquified natural gas for vessel propulsion or power generation on ship. IMO (International Marine time organization) currently allows the use of 0.1% sulfur containing diesel for off-shore and near-shore vessels.

In some embodiments, to mitigate sulfur from poisoning an MOC, a sacrificial sulfur trap device is placed before MOC in the exhaust system. A sulfur trap formulation is provided that can meet desired service intervals, and possibly providing additional methane conversion. To regenerate the sulfated MOC, an acid regeneration process is provided to bring the CH₄ conversion of MOC back to high conversion.

### BRIEF DESCRIPTION OF THE DRAWINGS

FIG. 1 illustrates a dual fuel exhaust in accordance with some embodiments.

FIG. 2 illustrates a MOC catalytic system in accordance with some embodiments.

FIG. 3 illustrates a MOC system testing result in accordance with some embodiments.

FIG. 4 illustrates a sacrificial sulfur trap testing result in accordance with some embodiments. Specifically, an assessment was carried out on a sacrificial sulfur trap installed upstream of the Pd-based MOC catalyst.

FIG. 5 illustrates various sulfur trap testing results in accordance with some embodiments. Specifically, various sulfur traps installed upstream of the Pd-based MOC catalyst.

FIG. 6 illustrates a sulfur trap formulation/structure in accordance with some embodiments.

FIG. 7 illustrates a sulfur trap/Pd-MOC dual function formulation/structure in accordance with some embodiments.

FIG. 8 illustrates an acid treated hydrothermal aged Pd-MOC recovering its conversion in accordance with some embodiments.

FIG. 9 illustrates the sulfur breakthrough measurement at 300° C. with a 12K h⁻¹ space velocity in accordance with some embodiments.

FIG. 10 illustrates the accumulated sulfur on the traps with respect to the trap efficiency at 300° C. with a 12K h⁻¹ space velocity in accordance with some embodiments.

FIG. 11 illustrates the accumulated sulfur on the traps with respect to the trap efficiency at 400° C. with a 47K h⁻¹ space velocity in accordance with some embodiments.

FIG. 12 illustrates the results from a cold start 10-cycle experiment in accordance with some embodiments.

Table 1 summarizes the functional sulfur adsorption capacity measured from sulfur breakthrough test in accordance with some embodiments.

### DETAILED DESCRIPTION OF THE INVENTION

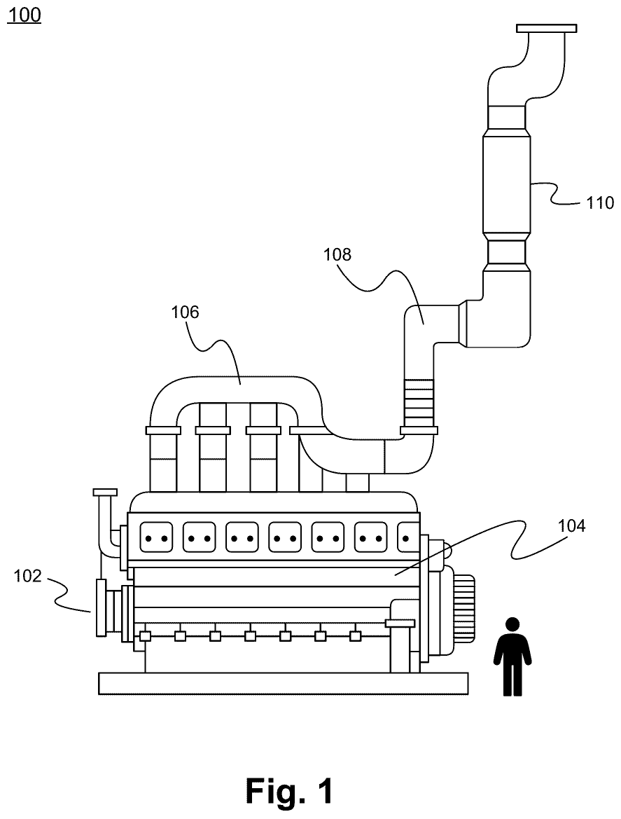

FIG. 1 illustrates a dual fuel exhaust system 100 in accordance with some embodiments. The dual-fuel engine 104 operates by combusting methane, with the crankshaft 102 converting the linear motion of the pistons into rotational energy. Exhaust gases are directed from the manifold chambers 106 to the exhaust riser 108, where the emission control system 110 is strategically positioned to manage and reduce pollutants.

A system uses 4300 kW Genset, set points at 100%, 75%, 25% and 10% loads. Depending on the load, typical exhaust temperature ranges between 300° C. to 500° C. For MOC activity study, the exhaust emissions containing ˜5% CO₂, <500 ppm CO, ˜150 ppm NO, and 3000 ppm methane, ˜9% O₂ and 12% steam are tested at 450° C. on the testing bench.

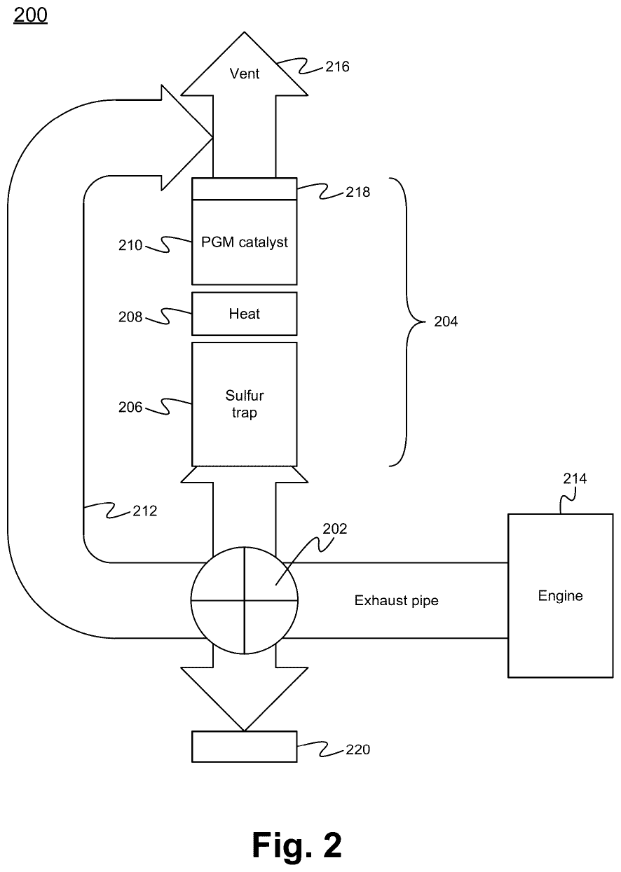

FIG. 2 illustrates a MOC catalytic system 200 in accordance with some embodiments. The exhaust aftertreatment system includes a valve 202 that directs the exhaust from an engine 214 through either the sulfur trap 206 and MOC catalyst 210 (e.g., an exhaust gas treatment system 204) or bypasses them (e.g., a bypass system 212) before merging back into the exhaust line 216, which eventually releases the gases into the atmosphere.

In a low temperature application (such as sustained exhaust temperature below 400° C.), a heating system 208 is installed in front of the MOC to maintain a temperature that maintains the MOC catalyst performance meeting the targeted methane conversion. An injection device with an integrated tank 218 is positioned downstream of the sulfur trap and MOC, maintaining an alignment from the engine exhaust to facilitate regeneration via gas, fuel or liquid injections. This approach creates a reducing environment that enables restoration of the active sites of the MOC catalyst. Chemical treatments, such as acid washing or the application of a water-based cleaner, can be applied to remove adsorbed sulfur from catalyst or sulfur trap surfaces from the treatment device 218 and the wastes are collected at the collector 220. A valve system 202 is positioned between the engine 214 and the sulfur trap 206, enabling exhaust gases to be routed through the sulfur trap and MOC system during fuel mode operation and/or cold start conditions.

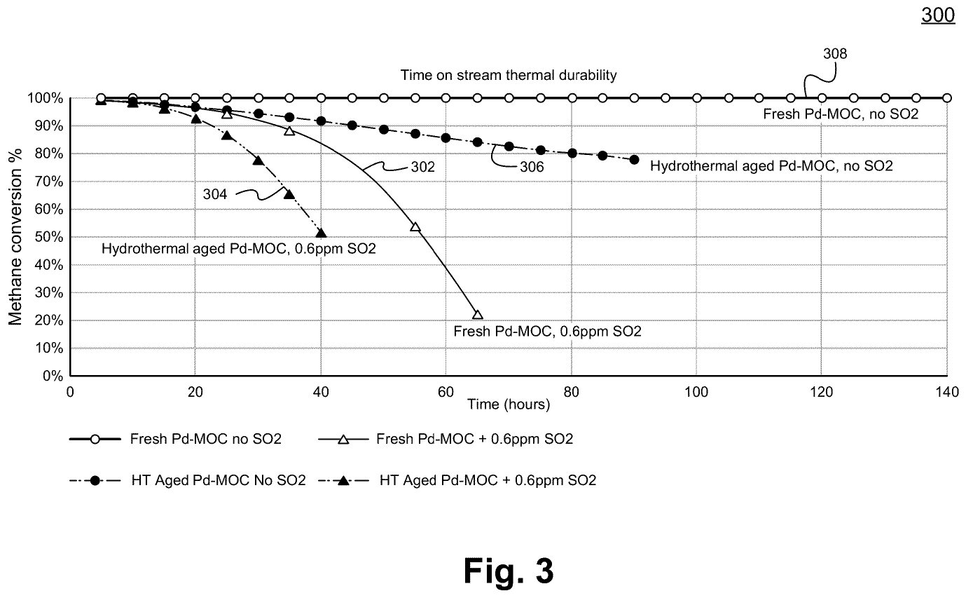

FIG. 3 illustrates a MOC system testing result 300 in accordance with some embodiments. Pd-MOC samples, both fresh Pd-MOC 308 and hydrothermally Pd-MOC aged at 700° C. with 10% water for 20 hours 306, are tested at 50% load exhaust conditions with and without 0.6 ppm sulfur. Sulfur poisoning, even at low concentrations, is found to be the primary cause of Pd-MOC deactivation. Fresh Pd-MOC 308 demonstrates nearly complete conversion over 140 hours of testing in the absence of SO₂ in the exhaust. However, exposure to 0.6 ppm SO₂ results in a 50% reduction in performance within 58 hours 302. Similarly, hydrothermally aged Pd-MOC 306 maintains conversion rates exceeding 80% after 80 hours without SO₂ exposure, but its efficiency drops below 50% within 40 hours when subjected to 0.6 ppm SO₂ in the exhaust 304. Preserving Pd-MOC performance requires more aggressive approach to extend the catalyst lifetime such as using a sulfur trap device to filter SOx and other harmful chemicals before the exhaust enters and interacts with MOC catalyst.

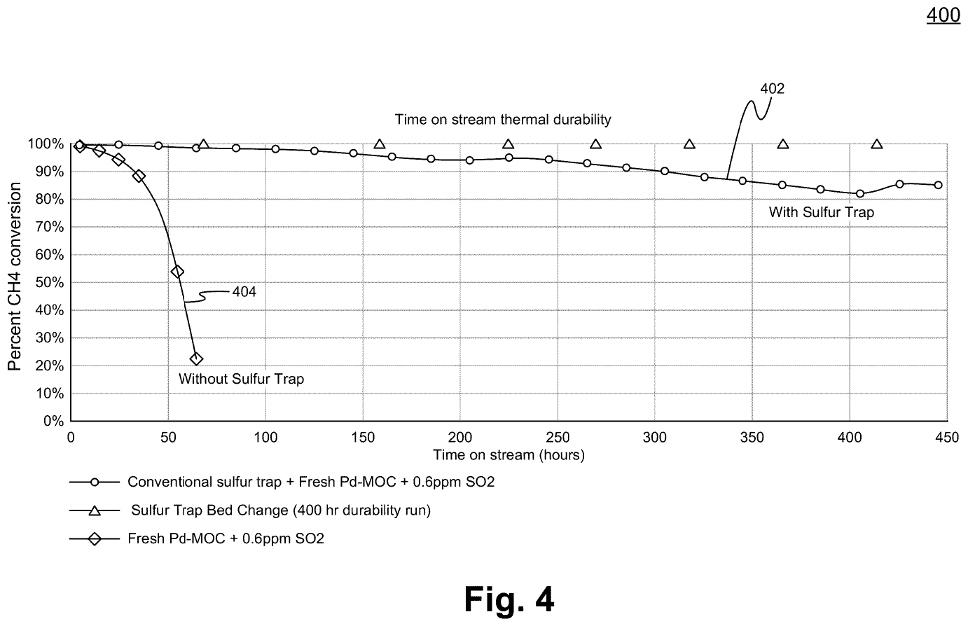

FIG. 4 illustrates a sacrificial sulfur trap with a Pd-MOC catalyst testing result in accordance with some embodiments. Sulfur at a concentration of 0.6 ppm is introduced into the exhaust at 50% load. In the absence of a sacrificial sulfur trap 404, Pd-MOC exhibited rapid deactivation after 54 hours. Conversely, when a copper-based sulfur trap 402 is positioned upstream of the Pd-MOC and replaced frequently as methane conversion declined, Pd-MOC performance is sustained over an extended period, demonstrating the trap's effectiveness in removing sulfur from the stream. In some embodiments, a sulfur trap before Pd-MOC catalyst is placed to extend the life of the Pd-MOC catalyst.

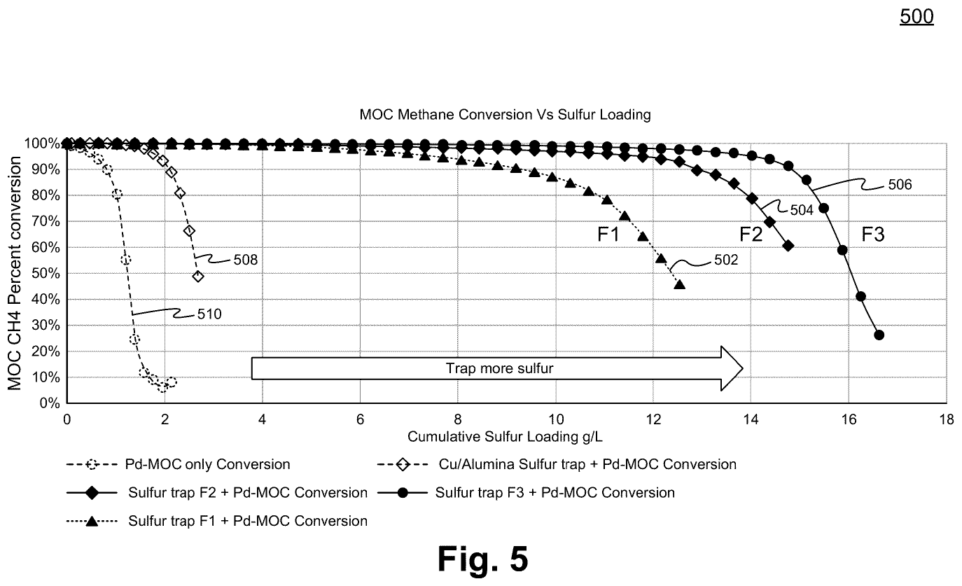

FIG. 5 illustrates various sulfur trap testing results 500 in accordance with some embodiments. The tests are conducted under the same conditions as previously described, at 450° C. The quantity of adsorbed sulfur, expressed as g/L, was plotted on the x-axis against methane conversion obtained from a system comprising a sulfur trap and Pd-MOC samples. A conventional copper-on-alumina sulfur trap 508 served as the baseline for comparison. In this study, we introduce three additional formulations, F1 502, F2 504, and F3 506, which demonstrate performance exceeding that of the conventional trap by factors of 2, 4, and 6, respectively. F1 502 can be a sulfur trap containing silica-doped alumina support oxide while copper oxide is introduced in the overcoat layer. F2 504 can be a sulfur trap containing Ceria-Zirconia oxides, Alumina and SSZ-13 zeolite supports on the cordierite substrate, while copper, manganese and cerium base metal oxides compound mixture are introduced in the overcoat layer. F3 506 contains a sulfur trap with Ceria-Zirconia oxides, Alumina, and ZSM-5 zeolite supports on a cordierite substrate. The overcoat layer can include copper, manganese, and cerium base metal oxide compounds, processed from a slurry or a solution containing aforementioned metal elements. It was observed that the addition of manganese and cerium oxide compounds enhances the sulfur trap capability compared to copper oxide alone on alumina. Replacing alumina support with a combination of alumina, cerium-based metal oxide, and zeolites such as SSZ13 and ZSM5 can further improve sulfur trap efficiency relative to alumina alone. The choice of zeolite in the support is also important for enhancing sulfur trap efficiency.

In some embodiments, the trap is prepared by two-layer coating process. First, the washcoat layer contains at least two of the following materials: Zeolite (porous materials with pore size between 0.2 nm to 1 nm), Cerium and Zirconium oxides (CZO) support and high surface area alumina support, preferably containing at least 50% Zeolite, 40% CZO and 10% Alumina. Si/Al ratio in Zeolite ranges between 15-35, preferably 21-32. CZO contains at least 30% Ceria in the support oxides. In some embodiments, CZO was employed as a support oxide containing at least 30% ceria, preferably composed entirely of ceria. Alumina support contains at least 95% Alumina oxide. Overcoat contains at least two of the following metals: Copper, Manganese, Cerium, Zinc, Nickle, Iron, Cobalt, Aluminum, Silicon, preferably Copper, Cerium and Manganese mixtures.

Theoretical sulfur dioxide adsorption capacities for selected metals can be calculated based on their sulfate chemical formulas. For example, one mole of copper oxide can adsorb one mole of sulfur to form copper sulfate CuSO₄, while one mole of cerium oxide can adsorb two moles of sulfur to form Cerium sulfate Ce(SO₄)₂.

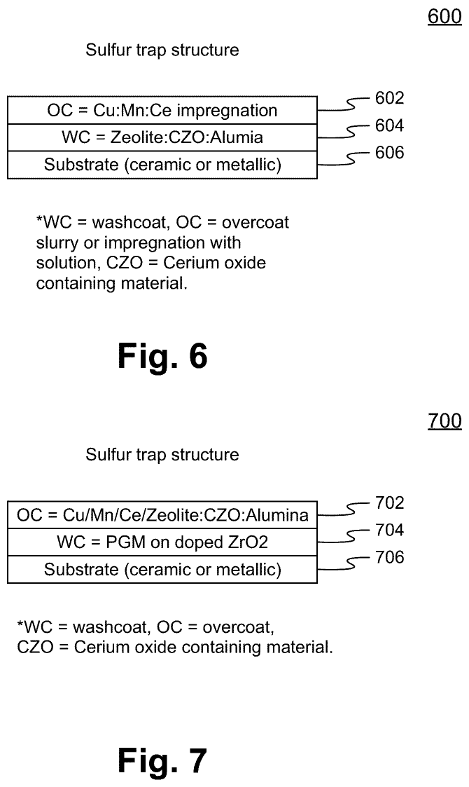

FIG. 6 illustrates a sulfur trap formulation/structure in accordance with some embodiments. The structure can be simplified by metalizing support materials to create a slurry, let it age for at least 4 hours, then coat it onto selected metallic or cordierite monolith substrates.

The structure 600 contains a monolith substrate 606. The substrate 606 is able to be ceramic or metallic. A washcoat (WC) layer 604 is able to be coupled with the substrate 606. The washcoat (WC) layer 604 is able to contain a zeolite:CZO:alumnia complex. The CZO is cerium oxide containing material, commonly also consisting of Zirconia oxides. In some embodiments, the WC layer contains only CZO support oxide or Ceria. A second layer 602 is able to be coupled with the washcoat (WC) layer 604, which is able to be an overcoat slurry or impregnation with solution.

In some embodiments, the materials of 604 and 602 are able to be integrated into one slurry form before coupling with the substrate 606 (e.g., combining the materials of 604 and 602, making it a slurry, and then applying the slurry onto the substrate 606). In some alternative embodiments, the materials of 604 and 602 are able to be combined into a unified powder form (e.g., materials of 604 and 602 are on powers) before converting it into a slurry and later coupling with the substrate 606.

To investigate the metals and support relationship, the samples with the same amount of theoretical sulfur adsorption capacity in metals are prepared according to FIG. 6 structure on honeycomb monolith substrates and listed in Table 1. For example, the Copper metal oxides loading in Sample A and Cu, Ce, Mn metal oxides mixture loading in Sample B (See Table 1) are adjusted accordingly so that the calculated total sulfur adsorption allowances in both samples are the same. In some embodiments, the samples are designed so that converting all metal oxides to metal sulfates allows adsorption of 16.5 g/L total sulfur. Sulfur adsorption capability is assessed by functional sulfur capacity using a breakthrough test. In some embodiments, the test uses a 10 L/min flow of 20 ppm sulfur dioxide, with 1000 ppm CO, 10% water, 10% oxygen, and N₂ as balance, unless otherwise specified. Sulfur dioxide levels are detected via FTIR.

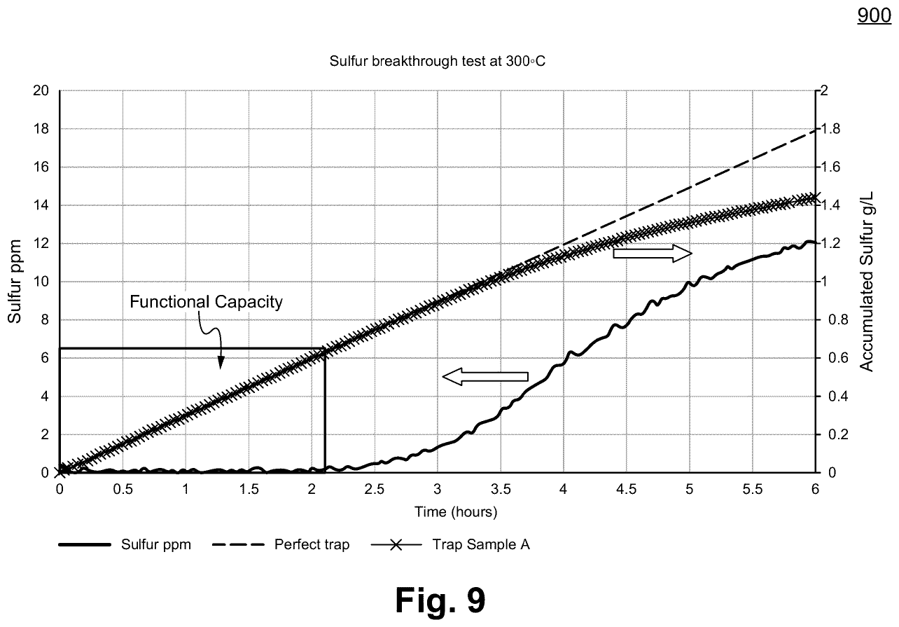

FIG. 9 shows result of Sample A (Copper oxide on Alumina support) at 300° C. and 12K h⁻¹ space-velocity in accordance with some embodiments. The initial zero detection of sulfur indicates that sulfur dioxide is fully trapped in the sample. The functional capacity of the sample is defined as the concentration of elemental sulfur (g/L) determined at the point of breakthrough onset. The functional sulfur adsorption capacity (C_{fs}) depends on adsorption temperature, sulfur concentration, and system flow design (space and linear velocities, etc.). FIG. 9 also illustrates an ideal trap system for sulfur accumulation (g/L), represented by the dashed line. At the onset of breakthrough, the sulfur uptake for Sample A deviates from this theoretical model, yielding a value of 0.67 g/L of C_{fs}.

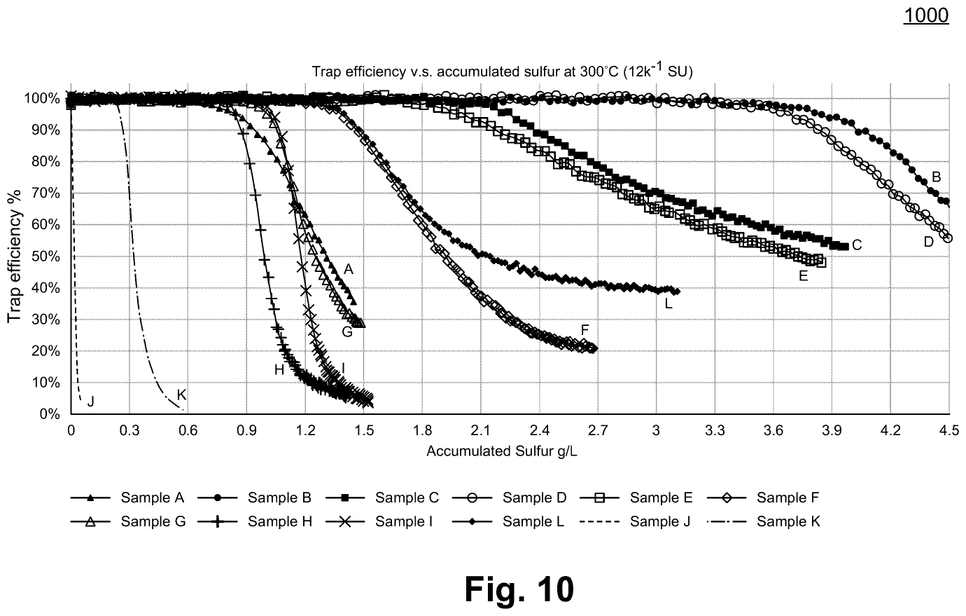

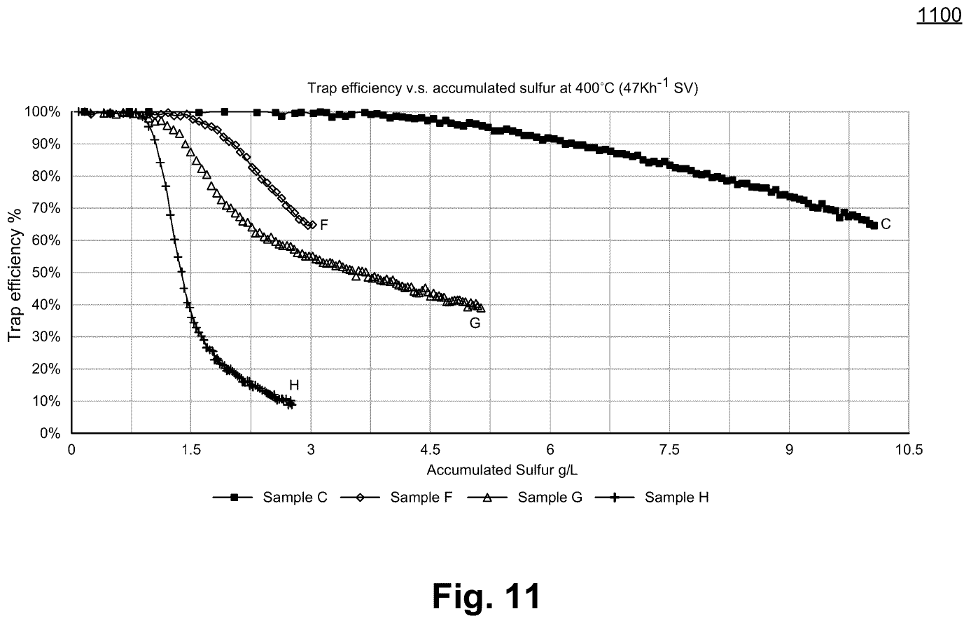

FIG. 10 provides a quantitative analysis of sulfur trap efficiency as a function of accumulated sulfur across multiple trap systems (Sample A to L) at 300° C., 12K h⁻¹ space velocity. The results enable to evaluate sulfur filtration mechanisms, adsorption capacities, and the resulting sulfur retention profiles for each formulation under the prescribed conditions. Accordingly, Table 1 presents the measured sulfur adsorption capacities for various systems at 300° C. The typical sulfation temperatures of Manganese oxide, Copper oxide and Cerium oxide are around 450° C., 500° C., and 550° C. respectively. FIG. 10 shows that at 300° C., the mixture of Copper, Manganese and Cerium oxide compounds with the ratio of 2:3:3 (Sample B) greatly enhances the C_{fs} compared to the conventional Copper only metal oxide on alumina (Sample A) as the sulfur adsorbent, resulting in an enhanced functional capacity by adding Cerium and Manganese with Copper at 300° C. (See Table 1).

In some embodiments, the support effect on sulfur adsorption capacity was investigated by incorporating cerium oxide containing material as a support into a sulfur trap. This approach utilizes the reversible oxygen storage and release capability of cerium-based materials to promote the oxidation of sulfur species and improve efficiency. The Ce⁴⁺/Ce³⁺ redox cycle supplies lattice oxygen, enabling rapid conversion of SO₂ to SO₃ and facilitating stable sulfate formation on basic trapping components. This mechanism improves sulfur uptake, reduces poisoning of active sites, and accelerates regeneration during rich or high-temperature conditions, resulting in higher capacity and durability compared to traps without ceria. In some embodiments, alumina (Sample B) and Cerium oxide containing supports (Sample D) yield the highest C_{fs} (3.34 g/L and 3.09 g/L respectively) in a Cu—Mn—Ce sulfur trap system at 300° C. (see FIG. 10). Upon increasing the trap temperature to 400° C. at the same 12K h⁻¹ space velocity, the measured C_{fs} values are 7.17 g/L and 10.02 g/L for Sample B and Sample D respectively, showing that the support of Cerium oxide containing supports improves performance at high temperature. In some embodiments, the mixed supports (Simple C) do not enhance trap efficiency, resulting in a loss of functional capacity at 300° C. and 12K h⁻¹ space velocity (1.89 g/L in Table 1). However, it reveals a highest C_{fs} of 10.14 g/L when the temperature increases at 400° C. In summary of Cu—Mn—Ce metal interactions across different support systems, i.e. Alumina supports (Sample B), Zeolite-CZO-Alumina composite supports (Sample C), and CZO supports (Sample D), Zeolite-CZO-Alumina composite supports reveals the most dramatic reversal between 300° C. and 400° C. Although it performs the worst at 300° C., its functional capacity increases by a factor of 5.3, becoming essentially the top performer at 400° C. This behavior indicates Sample C likely possesses higher activation energy or undergoes a phase change mechanism that kicks in strongly between 300° C. to 400° C. In contrast, the alumina supported system (Sample B) and CZO-supported systems (Sample D) demonstrate less sensitive to temperature jumps. Therefore, Alumina (Sample B) and CZO (Sample D) support systems show promising performance for lower temperature operation around 300° C., whereas the composite (Sample C) and CZO (Sample D) support systems benefit more for high-temperature operation at or above 400° C.

To underscore the distinct advantages of a Cu—Mn—Ce mixed metal oxide sulfur trap system, we systematically evaluated the adsorption efficiency of individual metal oxide systems, namely copper-only (Sample G), manganese-only (Sample F), and cerium-only (Sample H), utilizing identical mixed supports. Comparative analysis of the functional sulfur adsorption capacities (C_{fs}) revealed that Sample F (Mn-only), Sample G (Cu-only), and Sample H (Ce-only) exhibited C_{fs} values of 1.17 g/L, 0.89 g/L, and 0.77 g/L, respectively, as shown in Table 1. These capacities are all notably lower than the C_{fs} value of 1.89 g/L observed for Sample C, which incorporates the mixed Cu—Mn—Ce oxide system. This marked difference demonstrates the superior sulfur trapping performance and synergistic effect achieved by combining copper, manganese, and cerium oxides within the trap formulation, as opposed to employing the individual metal oxides alone. A similar trend appears at 400° C. and a higher space velocity of 47K h⁻¹, as shown in FIG. 11.

During real-world operation, the sulfur trap and MOC system handle cold starts, where the sulfur-containing exhaust begins at low temperatures before warming up to steady-state conditions. To evaluate sulfur trap performance under those conditions, a 10-cycle cold start experiment is conducted. Thes test uses a simulated gas mixture (5% CO₂, 9% O₂, 1400 ppm CH₄, 4 ppm SO₂, 250 ppm CO and NOx, 12% water with N₂ balance) at 60K h⁻¹ space velocity and compared two setups: (1) an MOC catalyst alone, and (2) an MOC catalyst with a sulfur trap structured as Sample C and placed in front.

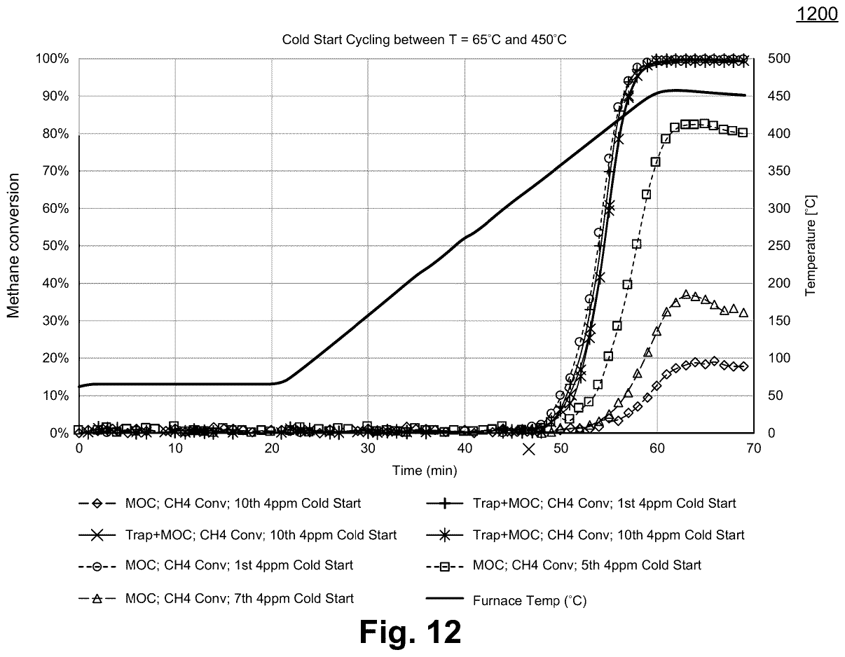

Throughout each cycle, temperatures are ramped from 65° C. to 450° C. at 10° C./min rate and cooled down in diluted 1.5% oxygen and 10% water, while CH₄ conversion is recorded. FIG. 12 presents the results. The dashed lines show that when only the MOC catalyst is used, CH₄ conversion declines drastically over repeated cycles due to sulfur poisoning. In contrast, the solid lines representing the system with the sulfur trap in front of the MOC catalyst illustrate that high conversion is maintained across all cycles. This demonstrates that the sulfur trap effectively adsorbs SO₂ at temperatures as low as 65° C. and above, protecting the MOC catalyst and ensuring consistent system performance during cold starts.

TABLE 1
Functional Sulfur Adsorption Capacity (C_{fs}) measured at 300°
C., 12K h⁻¹ space velocity and 20 ppm sulfur concentration.

| | | Measured functional |
|---|---|---|
| | | capacity C_{fs} at 300° C. |
| | Sulfur trap system | (g/L) |
| Sample A | Copper oxides on alumina | 0.65 |
| Sample B | Copper, Manganese and | 3.34 |
| | Cerium oxide compounds on | |
| | alumina | |
| Sample C | Copper, Manganese and | 1.89 |
| | Cerium oxide compounds on | |
| | alumina, CZO and zeolite | |
| | mixed support | |
| Sample D | Copper, Manganese and | 3.09 |
| | Cerium oxide compounds on | |
| | CZO | |
| Sample E | Copper, Manganese and | 1.69 |
| | Cerium oxide compounds on | |
| | Zeolite | |
| Sample F | Manganese oxides on alumina, | 1.17 |
| | CZO and zeolite mixed support | |
| Sample G | Copper oxides on alumina, | 0.89 |
| | CZO and zeolite mixed support | |
| Sample H | Cerium oxides on alumina, | 0.77 |
| | CZO and zeolite mixed support | |
| Sample I | CZO | 0.93 |
| Sample J | Zeolite | 0.03 |
| Sample K | Alumina, CZO and zeolite | 0.24 |
| | mixture | |
| Sample L | Copper oxides and Manganese | 1.13 |
| | oxide compounds on alumina, | |
| | CZO and zeolite mixed support | |

FIG. 7 illustrates a sulfur trap/Pd-MOC dual function formulation/structure 700 in accordance with some embodiments. The dual function catalyst is to use a sulfur trap overcoat to protect Pd catalyst in the washcoat layer.

The structure 700 contains a monolith substrate 706. The monolith substrate 706 is able to be ceramic or metallic. A washcoat (WC) layer 704 is able to be coupled with the substrate 706. The washcoat (WC) layer 704 is able to contain a PGM (Platinum Group Metals) on doped ZrO₂. An overcoat layer 702 is able to be coupled with the washcoat (WC) layer 704, which is able to be an overcoat with an empirical formulation of Cu/Mn/Ce/Zeolite:CZO:Alumina. CuₓMn_{γ}Ce_{z}/(Zeolite-CeO₂—ZrO₂—Al₂O₃), where x, y, and z denote the relative molar ratios of the active metal components. The composition comprises a composite catalytic material including a mixed oxide support and a metal-doped zeolitic phase. More specifically, the material includes copper (Cu), manganese (Mn), and cerium (Ce) species dispersed over a zeolite-ceria-zirconia-alumina (Zeolite:CZO:Alumina) matrix. The zeolite component provides high surface area and acidity for hydrocarbon adsorption, while the ceria-zirconia-alumina (CZO:Alumina) mixed oxide phase serves as a redox-mediator and thermal stabilization support. The transition metal dopants (Cu, Mn, and Ce) are incorporated either within the zeolitic framework or deposited on the oxide surface to enhance redox activity and catalytic performance.

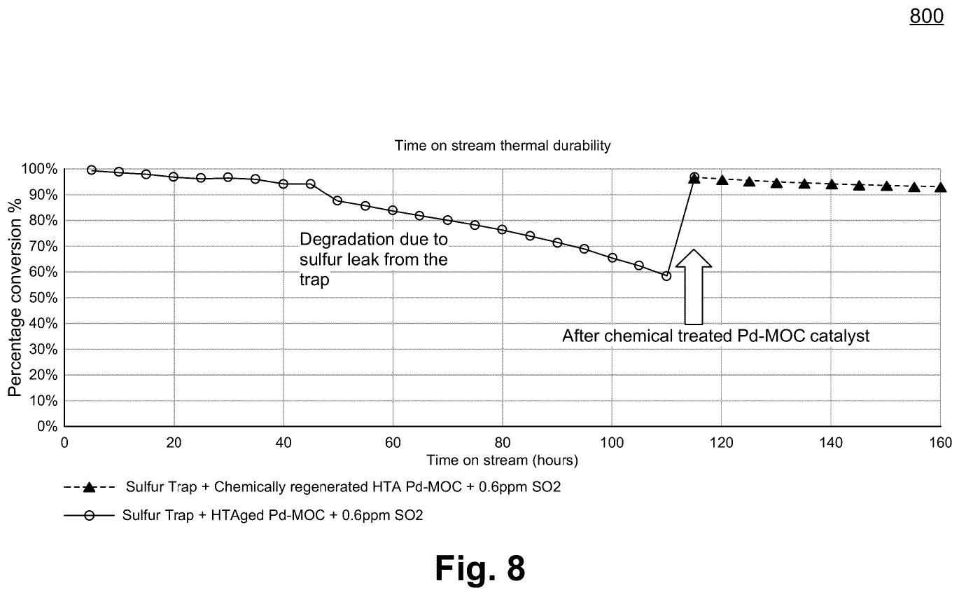

FIG. 8 illustrates an acid treated hydrothermal aged Pd-MOC recovering its conversion in accordance with some embodiments.

Acid treated or wet chemistry process for catalyst/trap regeneration. Immerse catalyst in the acid solutions (nitric acid, acetic acid, citric acid, hydrochloride acid, formic acid or other types of weak acid. Solution could be aqueous or in organic solvents) to facilitate ion-exchange, surface modification, contaminant removal or regeneration. Typical solution concentration ranges from 0.01M to 0.1M of acid solution or with pH values between 1-7. Acid solutions may be prepared in water (aqueous) or, if required for specific surface interactions, in compatible organic solvents such as ethanol or isopropanol. In some embodiments, the wet chemistry process is performed by washing with freshwater.

Pd preferably adsorbs on ZrO₂ surface at pH 6, adjust the solution pH. The Pd-sulfate or hydroxide surface recovered via redox or ion-exchange reaction. Pd ions adsorb on solid surface. Remove catalyst from the solution, recover the surface PdO active phase by calcination in air at 500° C.-600° C. for 2-10 h.

In utilization, methods and systems are provided to abate the methane slip in the exhaust. The catalyst used to remove methane includes a methane oxidation catalyst (MOC). In some embodiments, MOC contains precious metals group catalyst in the system. Methods and processes are provided to prevent the inactivation of the precious metals of the catalysts.

In operation, to mitigate sulfur attacking MOC, a sacrificial sulfur trap device is placed before MOC or any emission aftertreatment in the exhaust system, which is regenerated or replaced at a predetermined period.

The description is presented to enable one of ordinary skill in the art to make and use the invention. Various modifications to the described embodiments are readily apparent to those persons skilled in the art and the generic principles herein can be applied to other embodiments. Thus, the present invention is not intended to be limited to the embodiments shown but is to be accorded the widest scope consistent with the principles and features described herein. It is readily apparent to one skilled in the art that other modifications can be made to the embodiments without departing from the spirit and scope of the invention as defined by the appended claims.

What is claimed is:

1. A sulfur trap article configured for removing sulfur dioxide from an exhaust stream prior to contact with an emission reduction catalyst, the sulfur trap article comprising:
a monolithic honeycomb substrate;
a washcoat layer disposed on the substrate, the washcoat layer comprising:
(a) i) a zeolite having a Si/Al ratio between 15 and 35, ii) a cerium oxide-containing material, and (iii) alumina;
(b) cerium and zirconium oxides; or
(c) alumina;
a second layer disposed on the washcoat layer, comprising at least two metal oxide compounds selected from Cu, Mn, Ce, Zn, Ni, Co, Fe, Si, which are doped onto the washcoat;
wherein the sulfur trap is configured to adsorb sulfur dioxide and reduce sulfur to a level sufficient to prevent sulfur poisoning of the emission reduction catalyst.

2. The sulfur trap article of claim 1, wherein the substrate comprises a cordierite or a metallic honeycomb monolith.

3. The sulfur trap article of claim 1, wherein the washcoat layer comprises at least 50 wt % zeolite, 40 wt % ceria-zirconia, and 10 wt % alumina.

4. The sulfur trap article of claim 1, wherein the second coating layer comprises a mixed metal oxide compounds composition including copper, manganese, and cerium.

5. The sulfur trap article of claim 1, wherein the mixed metal oxide composition of copper, manganese, and cerium is in a 2:3:3 molar ratio.

6. The sulfur trap article of claim 1, wherein the sulfur trap exhibits a functional sulfur adsorption capacity of at least 1.8 g/L at 300° C. and 12K h⁻¹ space velocity.

7. The sulfur trap article of claim 1, wherein the sulfur trap exhibits a functional sulfur adsorption capacity of at least 10 g/L at 400° C. and 12K h⁻¹ space velocity.

8. A method of manufacturing a sulfur trap article, the method comprising:
(a) preparing a washcoat slurry comprising zeolite, a cerium-oxide material, and alumina;
(b) coating the slurry onto a monolithic honeycomb substrate to form a washcoat layer;
(c) applying a second coating layer comprising copper, manganese, and cerium metal precursors; and
(d) calcining the coated substrate to form a sulfur trap article configured to adsorb sulfur dioxide.

9. The method of claim 8, wherein calcination is performed at 400-650° C.

10. The method of claim 8, wherein the second coating layer comprises metal precursors in a 2:3:3 Cu:Mn:Ce molar ratio.

11. The method of claim 8, further comprising drying the coated substrate at 50-165° C. prior to calcination.

12. The method of claim 8, wherein the zeolite has a Si/Al ratio between 21 and 32.

13. The method of claim 8, wherein the substrate comprises a cordierite or a metallic honeycomb monolith.

14. An exhaust aftertreatment system comprising:
(a) an exhaust line receiving exhaust gas from a methane containing combustion device;
(b) a sulfur trap article positioned as a first functional treatment device downstream of the exhaust manifold, the sulfur trap article comprising:
(i) a washcoat layer containing zeolite, ceria-containing material, and alumina; and
(ii) copper, manganese, and cerium metal oxide compounds doped onto the washcoat; and
(c) a methane oxidation catalyst positioned downstream of the sulfur trap, wherein the sulfur trap reduces sulfur dioxide concentration to a level that prevents sulfur poisoning of the methane oxidation catalyst.

15. The system of claim 14, further comprising a bypass line and a valve configured to selectively route exhaust around the sulfur trap and methane oxidation catalyst.

16. The system of claim 14, wherein the sulfur trap reduces sulfur dioxide to 0.1 ppm or less prior to entering the methane oxidation catalyst.

17. The system of claim 14, wherein the methane oxidation catalyst comprises a palladium-based catalyst.

18. The system of claim 17, wherein the methane oxidation catalyst comprises a palladium-based catalyst having a precious-metal loading of 50-400 g/ft³.

19. The system of claim 14, further comprising an injection device configured to introduce a fuel, reducing gas, or chemical agent to regenerate the sulfur trap or the methane oxidation catalyst.

20. The system of claim 14, wherein the sulfur trap prevents at least 99 percent of sulfur dioxide from reaching the methane oxidation catalyst during normal engine operation.

21. The system of claim 14, further comprising a heating device applicable in a cold application configured to maintain the methane oxidation catalyst at a temperature suitable for methane conversion.
